(19) United States
(12) Patent Application Publication
(10) Pub. No.: US 2011/0202450 A1
(43) Pub. Date: Aug. 18, 2011

(54) Exchange Traded Note Indexed to a Single Product

(76) Inventors: Nicholas Cherney, Norwalk, CT (US); Gregory King, New Canaan, CT (US); William Lloyd, Westport, CT (US)

(21) Appl. No.: 13/095,485

(22) Filed: Apr. 27, 2011

Related U.S. Application Data
(63) Continuation of application No. 09/307,692, filed on May 10, 1999, now abandoned.
(60) Provisional application No. 61/328,372, filed on Apr. 27, 2010.

(51) Int. Cl. G06Q 40/00

(52) U.S. Cl. 705/37

(57) ABSTRACT

Systems and methods are provided for creating and managing Exchange Traded Notes (ETNs) which are indexed to a single product such as a stock or another financial instrument. The ETN may be created by selecting a stock, and conducting a broker poll to determine the level of the index related to the ETN.

### CROSS-REFERENCE TO RELATED PATENT APPLICATIONS

This application is a continuation of and claims priority under 35 USC §119(e) to U.S. Provisional Patent Application Ser. No. 09/307,692, filed Apr. 27, 2010.

### FIELD OF THE INVENTION

The invention relates generally to systems and methods for creating and managing exchange traded notes and the related index and, more particularly, to exchange traded notes indexed to a single product.

### BACKGROUND OF THE INVENTION

An exchange traded note (“ETN”) is a debt instrument, which is typically issued by a bank, and which is linked to the performance of a market index (e.g. trades on an exchange such as NYSE or NASDAQ and registered with the SEC). The issuer promises, upon maturity, to pay the amount reflected in the index less investor fees. When held to maturity, the investor receives a cash payment that is linked to the performance of the corresponding index during the period beginning on the trade date and ending at maturity, less investor fees.

The first ETN, marketed as the iPath Exchange-Traded Notes, was issued by Barclays Bank PLC in 2006. Presently, four types of ETNs are available in the market: Commodity ETNs (e.g. linked to raw materials and assets such as oil, natural gas, precious metals agriculture and livestock), Emerging Market ETNs (e.g. linked to such emerging markets as the MSCI India Total Return Index), Currency ETNs (e.g. linked to the value of a currency versus another currency) and Strategies ETNs (e.g. linked to the CBOE S&P 500 BuyWrite Index, also known as the BXM Index, which is designed to measure the total rate of return of a hypothetical “buy-write”, or “covered call”, strategy on the S&P 500 index).

It is not permissible, under current regulations, to issue a registered note indexed to a single product where the pricing of the benchmark index is based solely on the pricing provided by the issuer.

It would be advantageous to provide systems and methods for creating exchange traded notes which are indexed to a single product. It would also be advantageous to provide such systems and methods where the single product is a specific stock.

### BRIEF SUMMARY OF THE INVENTION

Many advantages of the invention will be determined and are attained by the invention, which in a broad sense provides systems and methods for creating and managing exchange traded notes and the related index.

Aspects of the invention provide a method of creating an exchange traded note (ETN) indexed to a financial product. The method includes transmitting, for receipt by a broker computer, a request for bids on an expected change in price for the ETN, using a server connected to a network. The method also includes receiving at the server bids corresponding to the expected change in a price of the financial product and, determining at the server a value for the ETN, based at least in part on a received bid.

Aspects of the invention provide a system for generating and managing an ETN which is indexed to a single product. The system includes a network and computers in electrical communication with each other via the network. At least one of the computers is operated by an issuer of the ETN, at least one of the computers is operated by a broker who is authorized to deal in the ETN, and the issuer computer is configured to provide a poll for an index related to the ETN to the broker computer. The issuer computer is also configured to receive a bid in response to the poll, and to determine a price for the ETN based at least in part on the received bid.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a flow diagram of a method for creating an ETN and managing the related index in accordance with one or more aspects of the invention, and;

FIG. 2 is a diagram of a system for managing ETNs in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

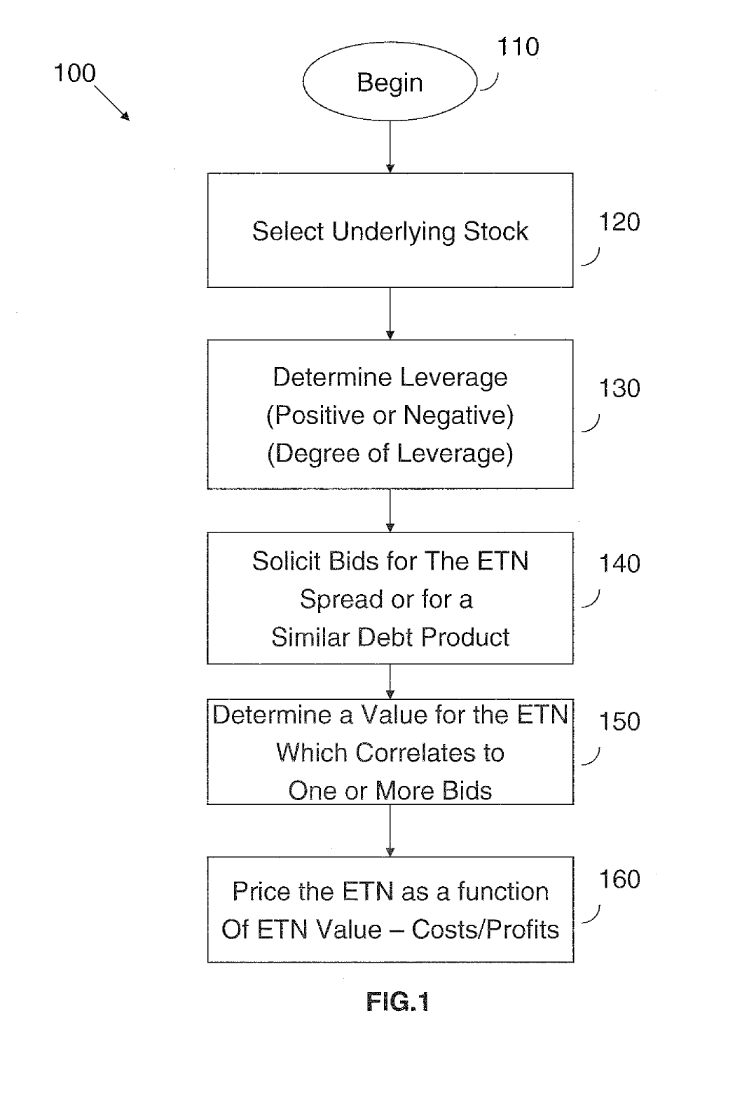

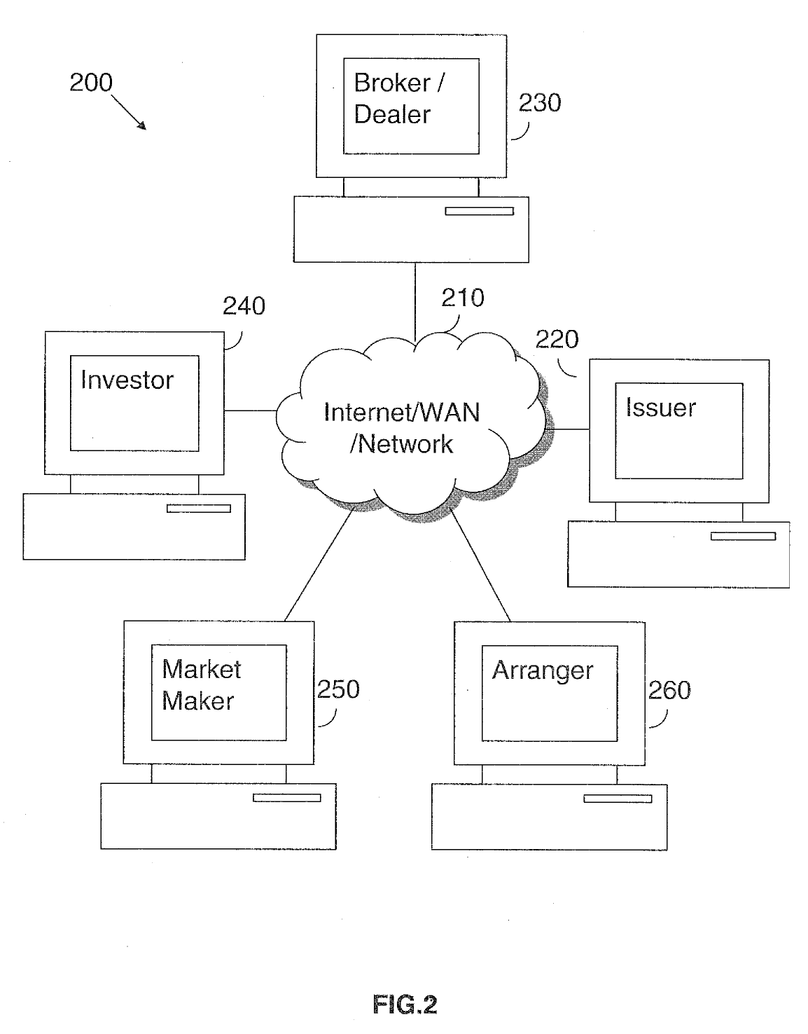

Referring to the drawings in detail wherein like reference numerals identify like elements throughout the various figures, there is illustrated in FIGS. 1-2 systems and methods for creating and managing exchange traded notes and the related index according to aspects of the invention. The principles and operations of the invention may be better understood with reference to the drawings and the accompanying description.

Various aspects of the invention will be described, and specific configurations will be set forth. However, the invention may be realized and/or practiced with some or all of these aspects. The invention may also be realized and/or practiced without all of the specific details provided below. In the following description well-known features or concepts may be omitted or their description simplified. However, such omission or simplification is in no way meant to detract from the invention and those skilled in the art will inherently recognize and understand the omitted description as if it were set forth in its entirety and will understand that the simplified description inherently implies the more complicated description.

The following description may be presented in terms of operations performed by a processor based device consistent with the manner commonly employed by those skilled in the art to convey the substance of their work to others skilled in the art. As is well understood by those skilled in the art, the quantities take the form of electrical, magnetic, or optical signals capable of being stored, transferred, combined, and otherwise manipulated through mechanical, electrical and/or optical components of the processor based device.

Various operations may be described as multiple discrete steps performed in a specific sequence. However, the order of presentation should not be construed as limiting. These operations need not always be performed in the order of presentation to fall within the scope of the invention.

The description may employ one or more of the phrases “one embodiment”, “an embodiment”, “various embodiments”, “an aspect of the invention”, and “aspects of the invention” when describing specific and general features of the invention. Each of these phrases individually may be construed as referring to a single embodiment and/or to multiple embodiments of the invention so as to incorporate the broadest meaning allowed for the description when viewed in light of existing technology.

In a preferred embodiment as illustrated in FIG. 1, the invention provides a method 100 for creating an Exchange Traded Note (“ETN”). At step 120 an underlying stock is selected. While the description focuses on a single stock, those skilled in the art will recognize that the invention may also be applicable to a different financial instrument (e.g. a bond, treasury note, American Depository Receipt, etc.), a custom group of stocks or a custom group of other financial instruments selected by the issuer. At step 130 a determination is made whether to leverage the stock and if so whether the leverage should be positive or inverse. At step 140, bids related to a spread for the expected change in value of the stock are solicited from broker/dealers and the bids, in conjunction with other market prices, are used to calculate the value of the index.

The bids may be solicited for either the ETN related index itself or for a similar product. The bids could be solicited through an online auction such as an English Auction, a Dutch Auction, a Vickrey Auction, etc. While the description refers to the process as an auction, those skilled in the art will recognize that this term is being used in its broadest sense and that it does not imply or require (although it does not negate the possibility either if that is the design choice of the issuer) that the trades will be awarded based solely on the basis of the bids provided during the auction process. The process may alternatively be referred to as a broker poll. Thus, for purposes of the description the terms may be used interchangeably.

The gross value of the ETN is determined based, at least in part, on the results of the auction and possibly the public market value of the stock(s). The value of the ETN may be determined as a function of the winning bid (the second highest bid in the case of the Vickrey type auction), an average or mean of the all or some (e.g. the top 5 bids, the top 10 bids . . . ) of the bids or some other correlation to the bids. At step 160 the level of the index is set and the ETN is underwritten.

By way of a non-limiting example, assume that at step 120 stock of XYZ corporation is selected as the underlying stock. The closing price for XYZ stock on the day prior to the creation of the ETN $100.00 (US). Assume that at step 30 it is decided that the leverage will be a multiple of 3. Thus return of the ETN will be 3 times the return on the price of XYZ stock minus a spread. The issuer of the ETN will solicit bids at step 140 for the value of the spread initially and again during each rebalancing period, which is typically (but not required to be) a day. Once the spread is determined, the ETN gross value is determined at step 150 (in this example 3*$100.00-spread). At step 160 the net value of the ETN is determined by subtracting the costs/profits from the gross value. This process may be repeated periodically to rebalance the value of the ETN one or more times prior to the maturity date of the ETN.

FIG. 2, illustrates a system 200 for creating and managing ETNs indexed to a single product such as a stock. Issuer 220 selects a stock as the index for the ETN.

Issuer 220 may directly or indirectly (e.g. through arranger 260) contact two or more broker/dealers 230 via a network 210 such as the Internet to solicit bids for an over the counter (“OTC”) swap with respect to the ETN based on the selected stock. Those skilled in the art will recognize that the initial contact could be realized through any secure communication other than the Internet, including, but not limited to, telephone calls, regular mail, courier, private networks, etc and still fall within the scope of the invention. Those skilled in the art will also recognize that while only a single broker/dealer 230 is illustrated, it is possible to have multiple brokers from the same broker/dealer 230 and/or single brokers from different broker/dealers 230 and/or multiple brokers from multiple broker/dealers 230 or any combination thereof take part in the auction.

The broker/dealers 230 log in to a broker poll via a network 210. As stated previously, various types of auction formats may be employed without departing from the scope of the invention. In a preferred, but not limiting embodiment, the auction is a standard Vickrey auction where the second best price is used to determine the level of the index. Since this type of auction is well known, it need not and thus will not be further described herein. Each broker/dealers 230 may be provided incentive to participate in the auction. For example, the trades may be allocated to the participating broker/dealers 230 based at least in part on the results of the auction. Broker/dealers 230 may be incentivized to participate in the broker poll for the opportunity to enter into valuable OTC swap arrangements with the issuer. Participating in the flow of such trading activity may also enable broker/dealers 230 to profit from their involvement. For example, the winning bidder could be provided with the first opportunity to purchase the ETN for resale. Once the broker poll is completed and the index level is determined the OTC swap trades are allocated to broker/dealers 230 and confirmed with the Issuer 220. The issuer 220 may then make the ETN or blocks of the ETN available for sale to market makers 250. Those skilled in the art will recognize that while only a single market maker 250 is illustrated, multiple market makers 250 may be employed/included. In turn the market makers 250 make the ETN available to Investors 240. As illustrated in FIG. 2, Investor 240 may purchase an ETN via a network 210. While only a single investor 240 is illustrated those skilled in the art will recognize that multiple investors 240 are more likely to be involved.

A return on investment (ROT) for the ETN is intended to reflect the economic return (or the leveraged return) of owning the stock over a given period. The price thus may include capital appreciation or depreciation and may take into account corporate actions such as dividends, splits, reverse splits, mergers, purchases, issuance of additional shares, buy back of shares, etc. The ROT may also take into account interest that would be paid on borrowed funds to obtain leverage or the interest that would be received from shorting an asset. For short indices, it may also reflect the cost to borrow the asset.

Having thus described preferred embodiments of the invention, advantages can be appreciated. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method of creating an exchange traded note (ETN) indexed to a financial product comprising:
transmitting, for receipt by a broker computer, a request for a bid on an expected change in a price of the financial product, using a server connected to a network;
receiving at said server a plurality of bids corresponding to the expected change in price of the financial product; and,
determining at said server a value for the ETN, based at least in part on a received bid.

2. The method according to claim 1 wherein the financial product is a publicly traded stock.

3. The method according to claim 1 wherein the financial product is a bond.

4. The method according to claim 1 wherein the financial product is selected from the group consisting of a stock, a bond, an exchange traded fund (ETF), an American depository receipt (ADR), a mutual fund, a real estate investment trust (REIT), an option and a warrant.

5. The method according to claim 4 wherein the financial product comprises a plurality of products; wherein said plurality includes at most 10 products.

6. The method according to claim 1 further comprising:
at least two of said plurality of received bids originating from different computers; and,
said value for the ETN being based at least in part on said at least two bids.

7. The method according to claim 1 wherein said plurality of received bids correspond to an expected change in a price of the financial product leveraged by a positive multiple.

8. The method according to claim 1 wherein said plurality of received bids correspond to an expected change in a price of the financial product leveraged by a negative multiple.

9. A system for generating and managing an exchange traded note (ETN) which is indexed to a single product, said system comprising:
a network;
a plurality of computers in electrical communication with each other via said network;
wherein at least one of said computers is operated by an issuer of said ETN;
wherein at least one of said computers is operated by a broker who is authorized to deal in said ETN;
wherein said issuer computer is configured to provide a poll for an index related to said ETN to said broker computer;
wherein said issuer computer is configured to receive a bid in response to said poll; and,
wherein said issuer computer is configured to determine a price for said ETN based at least in part on said received bid.

10. The system according to claim 9 further comprising an arranger computer configured to operate between said issuer and broker computers; wherein said arranger computer is configured to provide said poll to said broker computer and received said bids from said broker computer.

11. The system according to claim 10 wherein said arranger computer is configured to provide said poll to a plurality of broker computers, receive a bid from at least two of said broker computers; and determine a winning bid from said received bids.

12. The system according to claim 11 wherein said issuer computer is configured to receive said winning bid from said arranger computer and determine a value for the ETN, based at least in part on said winning bid.

13. The system according to claim 9 wherein said single product is a publicly traded stock.

14. The system according to claim 9 wherein said single product is a bond.

15. The system according to claim 9 wherein the single product is selected from the group consisting of a stock, a bond, an exchange traded fund (ETF), an American depository receipt (ADR), a mutual fund, a real estate investment trust (REIT), an option and a warrant.

16. The system according to claim 9 wherein said bid corresponds to an expected change in a price of the single product.

17. The system according to claim 9 wherein said bid corresponds to an expected change in a price of the single product leveraged by a positive multiple.

18. The system according to claim 9 wherein said bids corresponds to an expected change in a price of the single product leveraged by a negative multiple.
